(19) United States
(12) Patent Application Publication
(10) Pub. No.: US 2016/0229006 A1
(43) Pub. Date: Aug. 11, 2016

(54) METHODS FOR DETERMINING AT LEAST ONE DIMENSION OF A SUPERABRASIVE ELEMENT USING TWO-DIMENSIONAL IMAGES

(71) Applicant: US SYNTHETIC CORPORATION, Orem, UT (US)

(72) Inventor: Richard B. Smith, Spring, TX (US)

(21) Appl. No.: 14/065,052

(22) Filed: Oct. 28, 2013

Related U.S. Application Data
(60) Provisional application No. 61/720,493, filed on Oct. 31, 2012.

(51) Int. Cl. B23P 13/00; G06T 7/00

(52) U.S. Cl. CPC B23P 13/00; G06T 7/0004

(57) ABSTRACT

Embodiments of methods are disclosed for determining at least one dimension or a wear characteristic of a superabrasive element, such as a polycrystalline diamond cutting element. In an embodiment, a method for characterizing a superabrasive element using two-dimensional images is disclosed. Two images of a superabrasive element are obtained. A relationship between two dimensional coordinates on the two images and three-dimensional coordinates on the superabrasive element may be approximated using projective transformation techniques. A wear flat dimension on the superabrasive element may be determined or calculated using the approximated relationship between the two dimensional coordinates on the two images and the three-dimensional coordinates on the superabrasive element.

### CROSS-REFERENCE TO RELATED APPLICATIONS

This application claims priority to U.S. Provisional Application No. 61/720,493 filed on 31 Oct. 2012, the disclosure of which is incorporated herein, in its entirety, by this reference.

### BACKGROUND

Wear-resistant, superabrasive compacts are utilized in a variety of mechanical applications. For example, polycrystalline diamond compacts (“PDCs”) are used in drilling tools (e.g., cutting elements, gage trimmers, etc.), machining equipment, bearing apparatuses, wire-drawing machinery, and in other mechanical apparatuses.

PDCs have found particular utility as superabrasive cutting elements in rotary drill bits, such as roller cone drill bits and fixed cutter drill bits. A PDC cutting element typically includes a superabrasive diamond layer (also known as a diamond table). The diamond table is formed and bonded to a substrate using an ultra-high pressure, ultra-high temperature (“HPHT”) process. The substrate is often brazed or otherwise joined to an attachment member, such as a stud or a cylindrical backing The substrate is typically made of tungsten or tungsten carbide.

A rotary drill bit typically includes a number of PDC cutting elements affixed to a drill bit body. A stud carrying the PDC may be used as a PDC cutting element when mounted to a bit body of a rotary drill bit by press-fitting, brazing, or otherwise securing the stud into a receptacle formed in the bit body. The PDC cutting element may also be brazed directly into a preformed pocket, socket, or other receptacle formed in the bit body.

Conventional PDCs are normally fabricated by placing a cemented carbide substrate into a container or cartridge with a volume of diamond particles positioned on a surface of the cemented carbide substrate. A number of such cartridges may be loaded into an HPHT press. The substrates and volume of diamond particles are then processed under HPHT conditions in the presence of a catalyst material that causes the diamond particles to bond to one another to form a matrix of bonded diamond grains (i.e., crystals) defining a polycrystalline diamond (“PCD”) table. The catalyst material is often a metal-solvent catalyst, such as cobalt, nickel, iron, or alloys thereof that is used for promoting intergrowth of the diamond particles.

In one conventional approach, a constituent of the cemented carbide substrate, such as cobalt from a cobalt-cemented tungsten carbide substrate, liquefies and sweeps from a region adjacent to the volume of diamond particles into interstitial regions between the diamond particles during the HPHT process. The cobalt acts as a catalyst to promote intergrowth between the diamond particles, which results in formation of bonded diamond grains. During the HPHT process other components of the cemented carbide substrate, such as tungsten and carbon, may also migrate into the interstitial regions between the diamond crystals. The diamond crystals become mutually bonded to form a matrix of PCD, with interstitial regions between the bonded diamond grains being occupied by the solvent catalyst.

The wear resistance and thermal stability are important performance characteristics of a PDC and can vary greatly depending on the composition, structure, and manufacturing process used to fabricate the PDC. Therefore, it is important to be able to accurately characterize wear resistance and thermal stability of PDCs in order to be able to better design and manufacture PDCs.

### SUMMARY

Embodiments of the invention relate to methods for determining at least one dimension (e.g., wear flat areas) on worn PCD elements (e.g., a PDC cutting element or other superabrasive elements) using two-dimensional images and designing PCD elements, computer systems for implementing such methods, and a computer readable medium including computer executable instructions for instructing a processor to execute such methods. In an embodiment, a method for characterizing a worn superabrasive element (e.g., a PCD element) using two-dimensional images is disclosed. Two images of a worn superabrasive element may be obtained. A relationship between two dimensional coordinates on the two images and three-dimensional coordinates on the worn superabrasive element may be approximated using projective transformation techniques. At least one dimension (e.g., a wear flat area) on the worn superabrasive element may be determined using the approximated relationship between the two dimensional coordinates on the two images and the three-dimensional coordinates on the worn superabrasive element.

In an embodiment, a method for designing a manufacturing process for a PCD element is disclosed. A workpiece may be cut with a first superabrasive element so that the first superabrasive element develops a wear flat. A wear flat area of the first superabrasive element may be determined using one or more projective transformation techniques. A manufacturing process used to fabricate the first superabrasive element may be modified at least partially based on the determined wear flat area.

In an embodiment, a computer system includes at least one processor and a memory to which the at least one processor is operably coupled. The memory stores computer executable instructions thereon that when executed by the at least one processor causes the at least one processor to perform a method. The method may include any or all of the embodiments of methods described herein.

In an embodiment, a computer readable medium includes computer executable instructions stored thereon that when executed by a processor causes the processor to perform a method. The method may include any or all of the embodiments of methods described herein.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 is a cross-sectional view of a PCD element as the PCD element cuts a workpiece and develops a wear flat area to be determined.

FIG. 2 is a flow chart of a method of determining a wear flat area on a worn PCD element according to an embodiment.

FIG. 3 is a diagram for explaining a principle of direct linear transformation according to an embodiment.

FIGS. 4A and 4B are two images that may be obtained from different angles of a rotary drill bit and a calibration device using any of the embodiments of methods disclosed herein.

FIG. 5 is a flow chart of a method of designing a PCD element according to an embodiment.

FIG. 6 is an embodiment of a computer system configured to implement any of the methods disclosed herein.

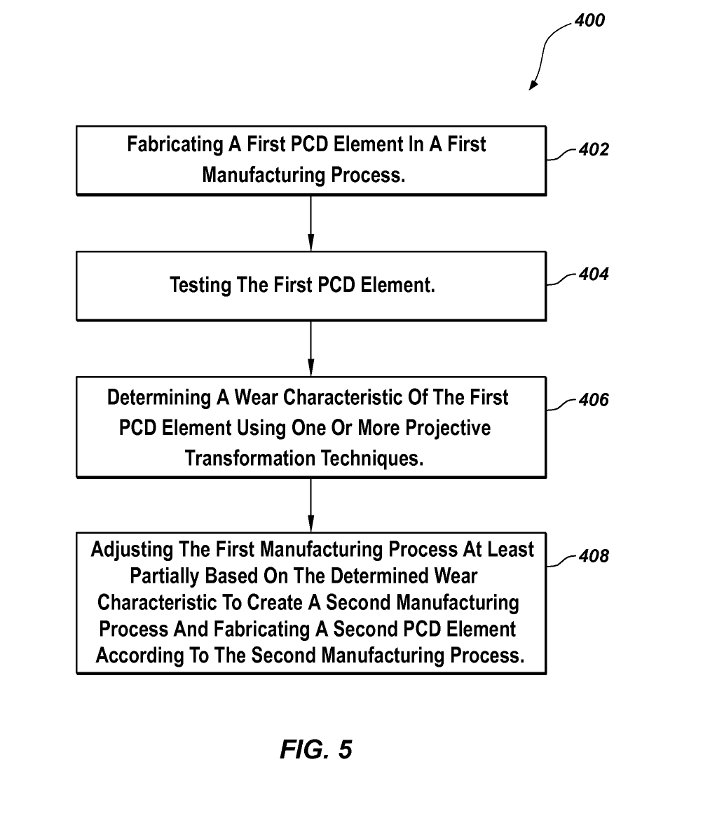

FIG. 7 is an isometric view of a PDC to be tested according to an embodiment.

FIG. 8 is a cross-sectional view of the PDC shown in FIG. 7 including a leached region formed in the PCD table according to an embodiment.

FIG. 9 is an isometric view of a rotary drill bit including PCD elements that have been tested and/or designed in accordance with an embodiment of the methods disclosed herein.

FIG. 10 is a top view of the rotary drill bit of FIG. 9.

### DETAILED DESCRIPTION

### I. Embodiments of Methods for Characterizing and Designing PCD Elements

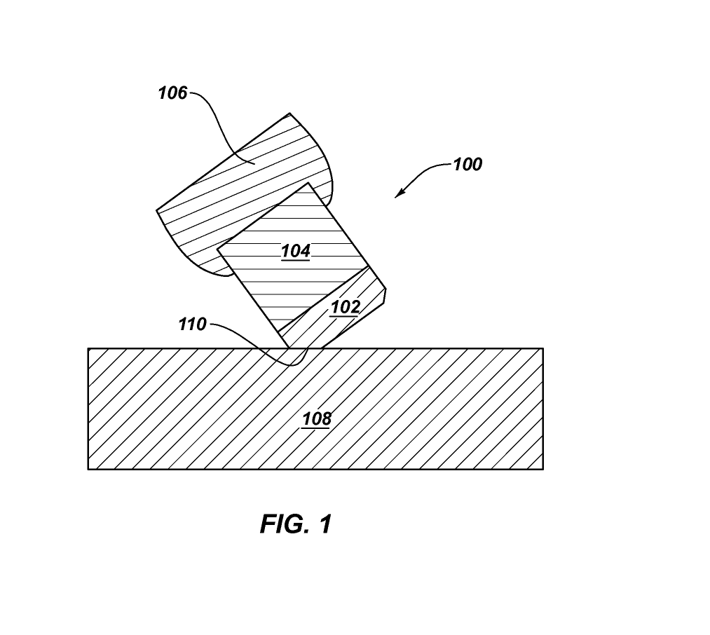

Embodiments of the invention are directed to methods for determining at least one dimension (e.g., wear flat areas) of worn PCD elements (e.g., a PDC or freestanding PCD element) or other superabrasive elements using two-dimensional images. FIG. 1 is a cross-sectional view of a worn superabrasive element 100 (depicted as a PDC having a PCD table 102 bonded to a substrate 104) developing a wear flat 110 due to material from the PCD element wearing away. In an embodiment, the worn superabrasive element 100 may comprise a tested PCD element. For example, as shown in FIG. 1, the worn superabrasive element 100 may comprise a PCD element being tested in a vertical turret lathe test fixture 106 as the PCD element/PDC 100 cuts a workpiece 108 and develops a wear flat 110. In other embodiments, the superabrasive element 100 may be configured as a superabrasive element deployed in earth-boring tools or drilling tools, wire dies, bearings, artificial joints, inserts, cutting elements, heat sinks, or the like.

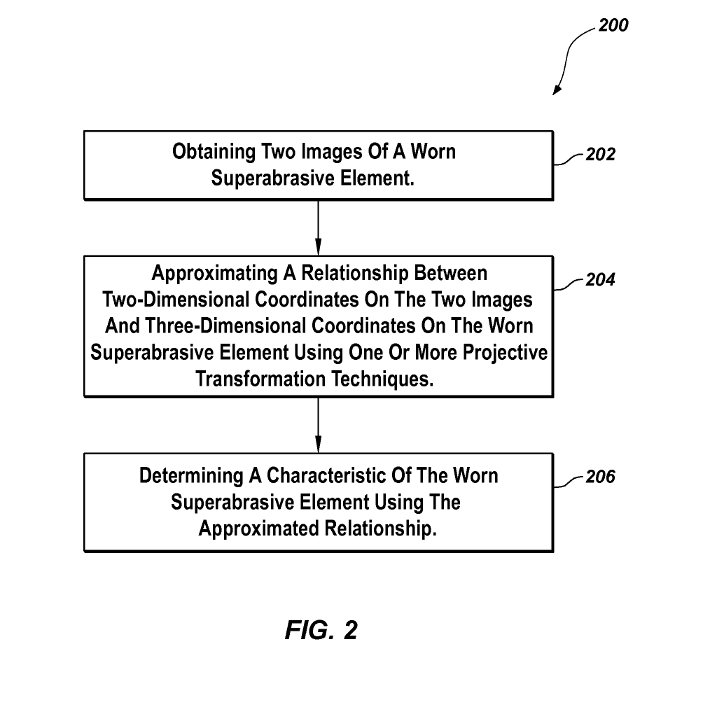

FIG. 2 is a flow chart of a method 200 of determining a wear characteristic of a worn superabrasive element using two-dimensional images according to an embodiment. The worn superabrasive element may be any of the superabrasive elements disclosed herein, such as a PDC or a freestanding PCD element/table. When the superabrasive element is being tested or used, a wear dimension to be determined may be defined solely in the PCD table or may further extend into a substrate to which it is attached, if applicable.

The method 200 includes an act 202 of obtaining two images of a worn superabrasive element. The two images may be obtained using any suitable device. For example, two images of the worn superabrasive element may be obtained using two imaging devices; one imaging device and one prism; one imaging device and an arrangement of mirrors; one imaging device, two separate images; or any other suitable technique. For example, the imaging device may be a digital camera, a film camera, a video camera, a movie camera, a scanner, or other suitable image capture device configured to capture an image (e.g., photograph). The images may be displayed on a computer screen or imprinted or encoded on a tangible medium.

Next, the method 200 includes an act 204 approximating a relationship between two-dimensional coordinates on the two images and three-dimensional coordinates on the worn superabrasive element using one or more projective transformation techniques. After approximating the relationship between the two-dimensional image coordinates and the three-dimensional coordinates, in act 206, a characteristic of the worn superabrasive element may be determined using the approximated relationship, such as a wear characteristic (e.g., wear area, wear length, wear width, wear volume, or other wear dimension). For example, a wear flat area may be determined by using the relationship approximated in act 206 to obtain three-dimensional coordinates of points of interest on the worn superabrasive element in order to calculate the wear flat area on the worn superabrasive element. In other embodiments, the relationship approximated in act 206 may be used to determine wear volumes (i.e., by calculating a difference between an initial volume and post-cut or post-worn volume of a superabrasive element), wear flats, or other physical characteristics of the worn superabrasive element or a test superabrasive element. Also, as briefly discussed above, the relationship approximated in act 206 may be used to determine length, width, or other dimensions of the worn superabrasive element or the test superabrasive element. In other embodiments, the relationship approximated in act 206 may be used to determine dimensions of a PCD element, drill bit, or other structure.

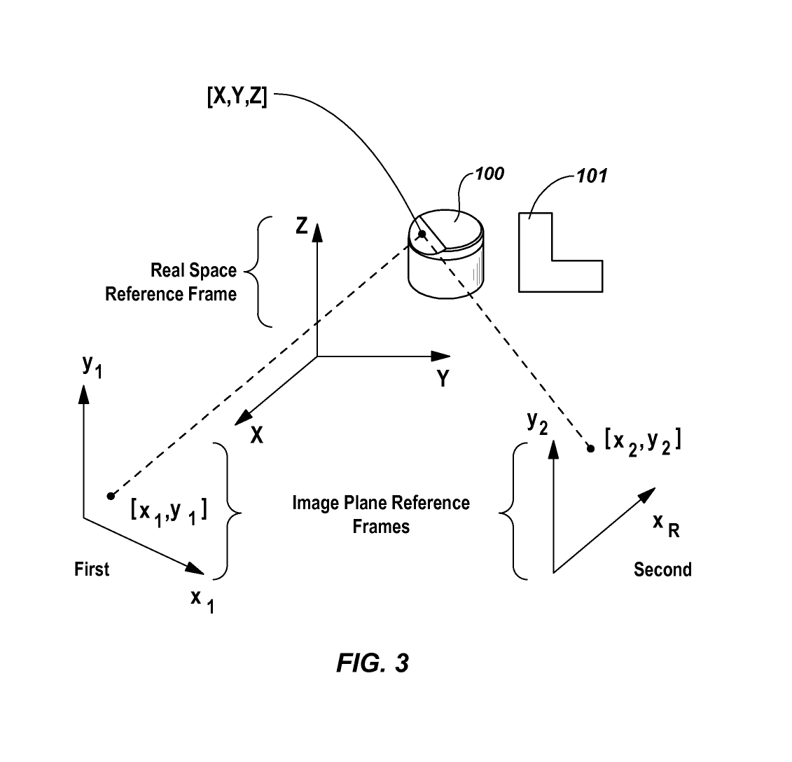

In an embodiment, using one or more projective transformation techniques may include using direct linear transformation (“DLT”) techniques. DLT is a method of locating the position of an object (or points on an object) in space using two views of the object. For example, as shown in FIG. 3, two images may be obtained of a worn superabrasive element 100 and a calibration device 101 positioned side-by-side. The worn superabrasive element 100 and calibration device 101 may lie in a real space reference frame that is referred to as the XYZ coordinate system. For example, the calibration device may be a reference marker, such as a fiducial mark having a known position on a plate or other suitable calibration device. This reference frame locates the worn superabrasive element 100 and calibration device 101 in real space. The XYZ coordinate system may have its origin in any suitable location. For example, the origin may be a point on the worn superabrasive element 100. In another embodiment, the origin may be a point on the calibration device 101.

Each of the two images may be associated with a two-dimensional image plane reference frame. These image plane reference frames are illustrated as first and second image plane reference frames. Consider the point [X, Y, Z] located on the worn superabrasive element 100 as shown in FIG. 3. This point appears in the first and second images, located by image coordinates [x₁, y₁] and [x₂, y₂], respectively. In an embodiment, the point [X, Y, Z] may have units of length (i.e., millimeters in SI units) and [x₁, y₁] and [x₂, y₂] may have units of pixels.

Using DLT techniques, the actual location of [X, Y, Z] may be determined or estimated using x₁, y₁, x₂, and y₂. The basic equation (1) of the DLT method is as follows:

$$x = \frac{{L}_{1} X + {L}_{2} Y + {L}_{3} Z + {L}_{4}}{{L}_{9} X + {L}_{10} Y + {L}_{11} Z + 1}$$

$$y = \frac{{L}_{5} X + {L}_{6} Y + {L}_{7} Z + {L}_{8}}{{L}_{9} X + {L}_{10} Y + {L}_{11} Z + 1}$$

In equation (1), [x, y] (first or second) are the image coordinates of reference points or unknown points; [X, Y, Z] are the three-dimensional coordinates of reference points or unknown points on the worn superabrasive element or calibration device; and L₁ to L₁₁ are unknown constants in the DLT method that relate the image coordinates and the three-dimensional coordinates. Reference points are points of known location in space. For example, as discussed below, the calibration device 101 may provide one or more reference or calibration points of known location to help obtain the unknown constants L₁ to L₁₁. In another embodiment, a point at the center of a wear or bearing surface may be known and may be used as a reference point. Unknown points are points of unknown location in space such as points of interest or points that may be used to determine a wear flat area on a worn superabrasive element 100. For example, in FIG. 3, point [X,Y,Z] is located on a wear flat and, therefore, may be an unknown point.

From equation (1), a linear equation (2) may be derived from equation (1) as shown below:

XL₁+YL₂+ZL₃+L₄−xXL₉−xYL₁₀−xZL₁₁=x

XL₅+YL₆+ZL₇+L₈−yXL₉−yYL₁₀−yZL₁₁=y

Equation (2) may be converted in matrix form as equation (3) as follows:

$$\vert \begin{matrix}X & Y & Z & 1 & 0 & 0 & 0 & 0 & - xX & - xY & - xZ \\ 0 & 0 & 0 & 0 & X & Y & Z & 1 & - yX & - yY & - yZ\end{matrix} \vert \vert \begin{matrix}{L}_{1} \\ {L}_{2} \\ {L}_{3} \\ {L}_{4} \\ {L}_{5} \\ {L}_{6} \\ {L}_{7} \\ {L}_{8} \\ {L}_{9} \\ {L}_{10} \\ {L}_{11}\end{matrix} \vert = \vert \begin{matrix}x \\ y\end{matrix} \vert$$

When equation (3) is solved, the eleven unknown constants from L₁ to L₁₁ that relate the image coordinates and the three-dimensional coordinates can be obtained. In an embodiment, equation (3) may be solved and/or the unknown constants L₁ to L₁₁ may be obtained using the least squares method, second-derivative methods, iterative techniques, other suitable problem solving techniques, or combinations of the foregoing. For example, in an embodiment, the image coordinates x₁, y₁, x₂, y₂, and the three-dimensional coordinates X, Y, and Z may be solved for using the least squares method and at least six reference or calibration points located on the calibration device 101 and/or the worn superabrasive element 100. For example, in an embodiment, a corner of the calibration device 101 may be positioned at the origin of XYZ coordinate system shown in FIG. 3 such that at least six reference or calibration points may be identified and selected on the calibration device 101. The image coordinates and the three-dimensional coordinates for the at least six reference or calibration points may then be arranged in equation (3) such that equation (3) may be solved to obtain the eleven unknown constants from L₁ to L₁₁.

Using the constants L₁ to L₁₁ and image coordinates for unknown points or point of interest, three-dimensional coordinates for the unknown points or points of interest on the worn superabrasive element 100 can be obtained to calculate or determine the worn flat area on the worn superabrasive element 100.

While the calibration device 101 is shown being imaged with the worn superabrasive element 100, in other embodiments, the calibration device 101 may be omitted. For example, in an embodiment, the worn superabrasive element 100 may be photographed or imaged alone and calibration points or reference points from the worn superabrasive element 100 or a drill bit may be used to obtain the eleven unknown constants from L₁ to L₁₁.

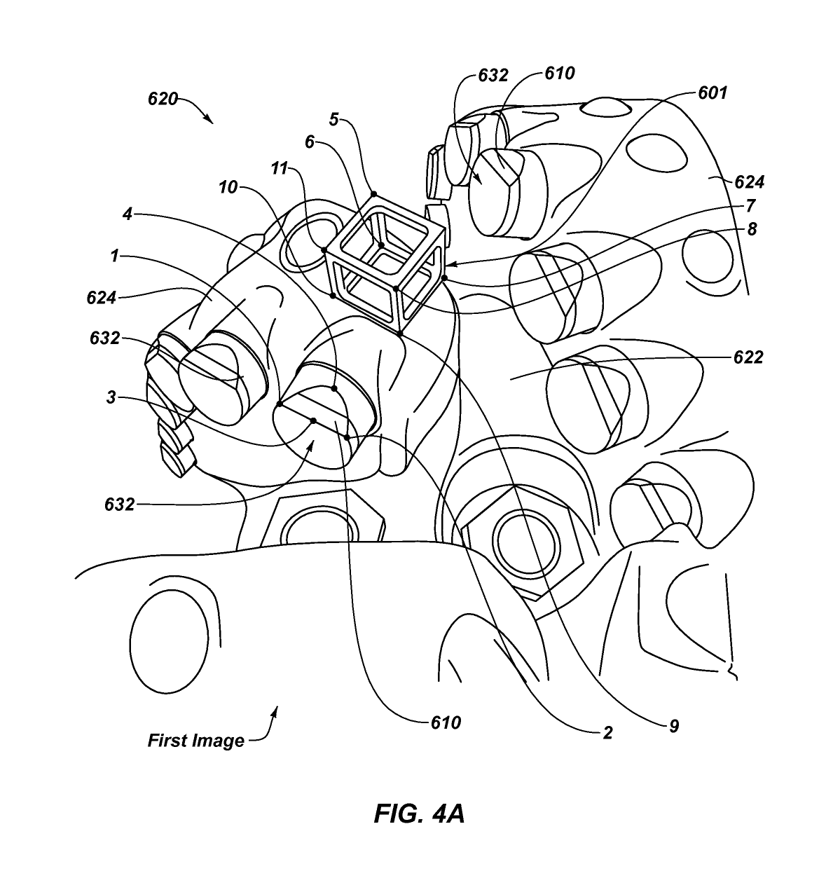

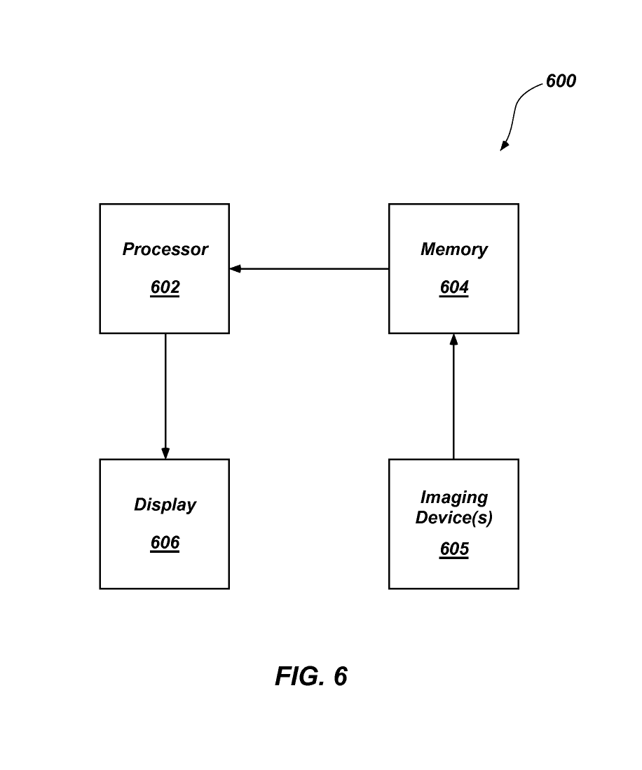

Such a configuration may allow three-dimensional distances and/or locations on PCD elements or other superabrasive elements to be measured or determined using two-dimensional images or photographs in test laboratories, field applications in which the superabrasive elements are secured to a drill bit, or in any other suitable environment. For example, as shown in FIGS. 4A and 4B, two images (illustrated as first and second images) may be obtained from different angles of a rotary drill bit 620 and a calibration device 601. The rotatory drill bit 620 may include a bit body 622 having radially and longitudinally extending blades 624. A plurality of PCD cutting elements 632, configured according to any of the PCD elements described herein (e.g., the PDC shown in FIG. 7), may be secured to the blades 624. One or more of the PCD cutting elements 632 may include a wear flat 610. As shown, the calibration tool 601 may be selectively positioned on the rotary drill bit 620. Using the first and second images, image coordinates [(x₁, y₁), (x₂, y₂)] for points 1-4 (e.g, points of interest) may be identified on the wear flat 610 of at least one of the PCD cutting elements 632. Image coordinates [(x₁, y₁), (x₂, y₂)] and three-dimensional coordinates [X, Y, Z] for known reference points 5-11 may also be identified and selected on the calibration device 601. Using the image coordinates [(x₁, coordinates [(x₁, y₁), (x₂, y₂)] and the three-dimensional coordinates [X, Y, Z] for reference points 5-11, a relationship between the image coordinates [(x₁, y₁), (x₂, y₂)] and the three-dimensional coordinates [X, Y, Z] for reference points 5-11 may be determined or approximated. Using this approximated relationship and image coordinates [(x₁, y₁), (x₂, y₂)] for points 1-4, three-dimensional coordinates for points 1-4 may be obtained, which can be used to calculate or determine one or more wear characteristics of the wear flat 610, including, but not limited to, a length, a height, an area, a volume, combinations thereof, or the like. These determinations may be used for design testing, safety assessments, operational and/or performance analysis, combinations thereof, or any other suitable purpose.

In another embodiment, a method of determining a wear characteristic of a PCD element may include cutting a workpiece with a first PCD element or other superabrasive element so that the first PCD element develops a wear flat. Next, the method includes an act of determining a wear characteristic of the first PCD element using one or more direct linear transformation techniques as disclosed herein. Optionally, the process of cutting the working piece and determining the wear flat area of the first PCD element may be repeated, as desired. In testing, non-limiting examples of specific cutting tests that may be performed on the PCD elements to be tested using a vertical turret lathe are discussed below. For example, abrasion resistance of a PCD element may be evaluated by measuring at least one of the wear flat area, dimension, or volume of the PCD element versus at least one of the wear flat area, dimension, or volume of a Barre granite workpiece, while the workpiece is cooled with water. The test parameters may include a depth of cut for the PCD element of about 0.254 mm, a back rake angle for the PCD element of about 20 degrees, an in-feed for the PDC of about 6.35 mm/rev, and a rotary speed of the workpiece to be cut of about 101 RPM.

The thermal stability of a PCD element may also be evaluated by measuring the distance cut in a Barre granite workpiece prior to failure, without using coolant, in a vertical turret lathe test. The distance cut is one measure of the thermal stability of the PCD element. The test parameters may be a depth of cut for the PCD element of about 1.27 mm, a back rake angle for the PCD element of about 20 degrees, an in-feed for the PCD element of about 1.524 mm/rev, and a cutting speed of the workpiece to be cut of about 1.78 msec.

A wear flat will develop in the PCD element being tested during both the abrasion resistance and thermal stability tests discussed above. A wear characteristic of the PCD element may be determined using, for example, the inventive method 200 discussed above.

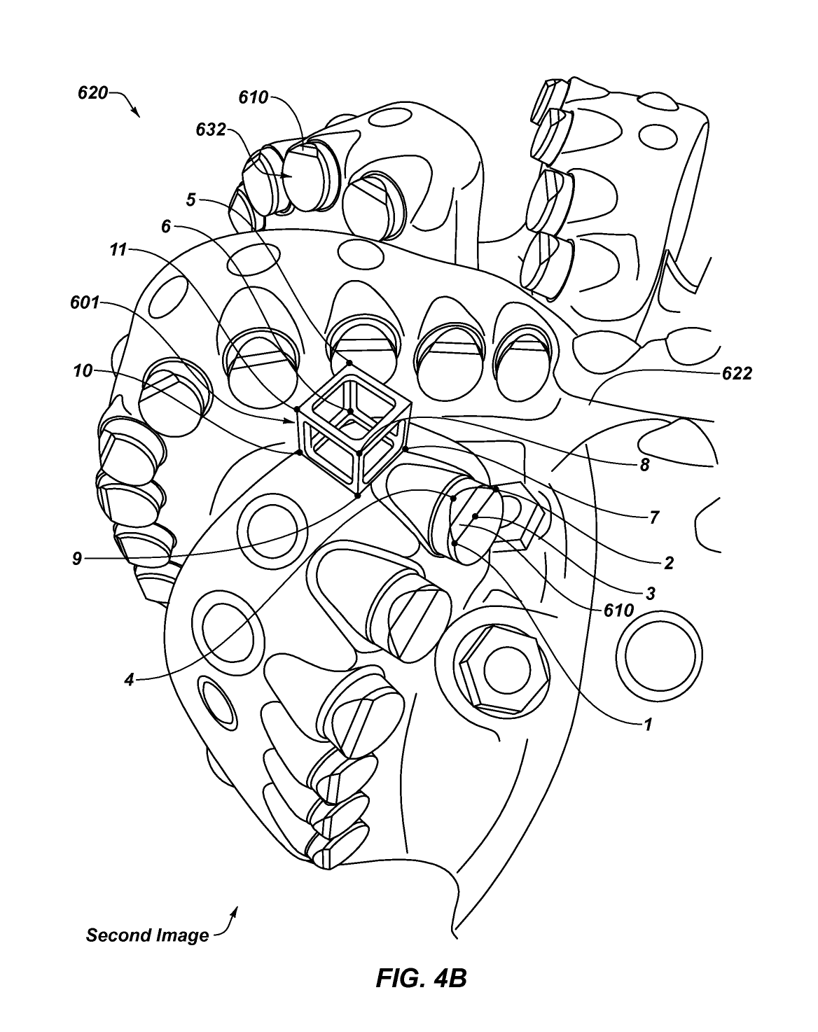

As noted above, any of the methods described herein may be used when designing PCD elements. For example, FIG. 5 is a flow chart of a method 400 of designing a PCD element according to an embodiment. The method 400 includes an act 402 of fabricating a first PCD element in a first manufacturing process, such as a first HPHT process. The method 400 further includes an act 404 of testing the first PCD element until a wear flat develops. After testing the PCD element, the method 400 includes an act 406 of determining a wear characteristic of the tested first PCD element using any of the projective transformation techniques disclosed herein. In act 408, one or more process parameters of the first manufacturing process used to fabricate the first PCD element may be adjusted at least partially based on the determined wear flat area of the first PCD element to create a second manufacturing process and a second PCD element may be fabricated according to the second manufacturing process, such as a second HPHT process.

In an embodiment, the process may be repeated one or more times. For example, the second PCD element fabricated according to the adjusted manufacturing process may be tested as in act 404, the wear characteristic of the second PCD element may be determined using two-dimensional images and projective transformation techniques, and (if desired or needed), the second manufacturing process used to fabricate the second PCD element may be adjusted.

In an embodiment, the one or more process parameters that may be adjusted in the method 400 may affect synthesis of the diamond structure (e.g., the extent of diamond-to-diamond bonding) in the PCD element. In another embodiment, the process parameters that may be adjusted in the method 400 may affect wear resistance and/or thermal stability of the PCD element. Examples of process parameters that may be adjusted at least partially based on the determined wear flat area of the PCD element include, but are not limited to, HPHT sintering temperature, HPHT sintering pressure, precursor diamond particle size and/or composition used to form the PCD element, catalyst composition, amount of catalyst used in the fabrication of the PCD element, composition of a leaching medium used to leach catalyst from the PCD element, pH of an acid composition used to leach catalyst from the PCD element, leaching time used in a leaching process to leach catalyst from the PCD element, leaching temperature used to leach catalyst from the PCD element, leaching pressure used to leach catalyst from the PCD element, combinations thereof, or another suitable process parameter.

In an embodiment, the sintering temperature and/or the sintering pressure may be adjusted to affect the fabrication of the PCD element and/or affect the performance characteristics of the PCD element. As discussed in greater detail below, PCD elements are fabricated by placing diamond particles into an HPHT cell assembly and subjecting the cell assembly and the diamond particles therein to HPHT conditions (e.g., about 1100° C. to about 2200° C., or about 1200° C. to about 1450° C. and a pressure of at least about 5 GPa, 7.5 GPa to about 15 GPa, about 9 GPa to about 12 GPa, or about 10 GPa to about 12.5 GPa) for a time sufficient to sinter the diamond particles together in the presence of a metal-solvent catalyst. The pressure values employed in the HPHT processes disclosed herein refer to the pressure in a pressure transmitting medium of the HPHT cell assembly at room temperature (e.g., about 25° C.) with application of pressure using an ultra-high pressure press and not the pressure applied to the exterior of the cell assembly. The actual pressure in the pressure transmitting medium at sintering temperature may be slightly higher. The metal-solvent catalyst may be infiltrated from substrate placed adjacent the diamond particles, provided from a thin layer of metal-solvent catalyst, mixed with the diamond particles, combinations of the foregoing, or in any suitable manner. Vertical turret lathe testing of a PCD element provides a characterization technique that enables sintering parameters to be adjusted (e.g., raising/lowering the temperature and/or the pressure and/or altering the time in the pressure cell) to affect performance parameters, such as degree of diamond grain growth, extent of diamond-to-diamond bonding, and the concentration of metal-solvent catalyst incorporated into the PCD during the HPHT process.

In another embodiment, the precursor diamond particle size used to form the PCD element may be adjusted at least partially based on the determined wear volume of the tested PCD element. The diamond particles used to fabricate the PCD element may exhibit an average particle size of, for example, about 50 μm or less, such as about 30 μm or less, about 20 μm or less, about 10 μm to about 18 μm or, about 15 μm to about 18 μm. In some embodiments, the average particle size of the diamond particles may be about 10 μm or less, such as about 2 μm to about 5 μm or submicron. It is noted that the sintered diamond grain size in the PCD element may differ from the average particle size of the mass of diamond particles prior to sintering due to a variety of different physical processes, such as grain growth, diamond particle fracturing, carbon provided from another carbon source (e.g., dissolved carbon in the metal-solvent catalyst), or combinations of the foregoing.

In yet another embodiment, one or more of a catalyst composition, an amount of catalyst used in the fabrication of the PCD element, or a catalyst concentration in the fabricated-un-leached PCD element may be at least partially based on the determined wear volume of the tested PCD element. Metal-solvent catalyst concentration and/or catalyst composition may affect performance of the PCD elements by affecting, for example, thermal stability of the PCD element, impact resistance, and chemical stability.

Metal-solvent catalyst may be introduced into the PCD element by any number of processes. If, for example, the substrate includes a metal-solvent catalyst, the metal-solvent catalyst may liquefy and infiltrate the mass of precursor diamond particles during the HPHT process to promote growth between adjacent diamond particles of the mass of diamond particles to form the PCD element. For example, if the substrate is a cobalt-cemented tungsten carbide substrate, cobalt from the substrate may be liquefied and infiltrate the mass of diamond particles to catalyze formation of the PCD element. Sintering temperature and/or pressure and precursor diamond particle size may affect the amount of catalyst that infiltrates into the PCD element during the HPHT process.

Catalyst concentration in the PCD element may also be altered on subsequent to HPHT sintering by leaching at least a portion of the catalyst from the PCD element using an acid leaching process. Acid leaching is a time consuming and often difficult process. Monitoring the catalyst concentration in the PCD element before, during, and after the leaching process (e.g., by measuring magnetic saturation) may enable the leaching process parameters to be adjusted in order to achieve desired characteristics in the PCD element and/or a selected catalyst concentration in the PCD element after leaching.

In an embodiment, the concentration of catalyst in the PCD element either before or after leaching may be less than about 5 weight % (“wt %”). For example, the concentration of catalyst in the PCD element either before or after leaching is less than about 2 wt %, less than about 1 w t %, or about 0.5 wt % to about 1.5 wt %.

At least partially based on the determined wear flat area of the PCD element, one or more characteristics of the acid composition used to leach catalyst from the PCD element, pH of the acid composition used to leach catalyst from the PCD element, leaching time used in a leaching process to leach catalyst from the PCD element, leaching temperature used to leach catalyst from the PCD element, leaching pressure and/or temperature used to leach catalyst from the PCD element may be adjusted, or combinations of the foregoing.

In an embodiment, acts of any of the methods described above may be performed by a computer system 600 having at least one processor 602 configured to execute computer executable instructions and process operational data. For example, the processor 602 may be operably coupled to a memory 604 storing an application including computer executable instructions and operational data constituting a program to perform acts 202, 204, and/or 206 of method 200. One or more of any of the disclosed imaging devices 605 may be operably coupled to the memory 604 so that images acquired by the one or more imaging devices 605 are stored in the memory 604. In other embodiments, the processor 602 may be operably coupled to the memory 604 that may store an application including computer executable instructions and operational data constituting a program to perform acts 402, 404, 406, and/or 408 of method 400. For example, the processor 602 may be operably coupled to the memory 604 storing an application including computer executable instructions and operational data constituting a program to determine wear flat area of a worn PCD element using projective transformation techniques.

The memory may be embodied as a computer readable medium, such as a random access memory (“RAM”), a hard disk drive, or a static storage medium such as a compact disk, DVD, or the like. The memory may further store property data describing properties of one or more PCD elements determined as described hereinabove. The computer system may further include a display 606 coupled to the processor 602. The processor 602 may be operable to display the images of the PCD element and other graphical illustrations of the properties of the PCD element on the display 606, as discussed hereinabove.

In some embodiments, the processor may also be operably coupled to and control the operation of a camera, scanner, or other suitable image capture device that produces images of worn PCD element or a PCD element of interest. For example, the memory may further have computer executable instructions stored thereon for having the processor direct the camera, scanner, or other suitable image capture device to capture images of the worn PCD element as performed in act 202 of the method 200. It will be appreciated that the computer systems described herein may include any suitable computer system including personal computers, desktop computers, laptop computers, message processors, hand-held devices, multi-processor systems, microprocessor-based or programmable consumer electronics, network PCs, minicomputers, mainframe computers, mobile telephones, PDAs, tablets, combinations thereof, or the like.

### II. PCD Elements and PDCs, and Applications for PCD Elements and PDCs

PCD elements that may be tested and characterized using the methods disclosed herein include one-step and two-step PDCs including PCD tables attached to a substrate and freestanding PCD tables/elements. A one-step PDC may include a PCD table integrally formed and bonded to a cemented carbide substrate. The PCD table includes directly bonded-together diamond grains exhibiting diamond-to-diamond bonding (e.g., sp³ bonding) therebetween that define a plurality of interstitial regions. FIG. 7 illustrates an embodiment of a PDC 500 including a PCD table 502 and a cemented carbide substrate 504. The PCD table 502 includes at least one lateral surface 505, an upper exterior working surface 503, and may include an optional chamfer 507 formed therebetween. It is noted that at least a portion of the at least one lateral surface 505 and/or the chamfer 507 may also function as a working surface (e.g., that contacts a subterranean formation during drilling operations).

A metal-solvent catalyst (e.g., iron, nickel, cobalt, or alloys thereof) is disposed in at least a portion of the interstitial regions between adjacent diamond grains. The cemented carbide substrate 504 may comprise tungsten carbide, tantalum carbide, vanadium carbide, niobium carbide, chromium carbide, titanium carbide, or combinations of the foregoing carbides cemented with iron, nickel, cobalt, or alloys of the foregoing metals. For example, the cemented carbide substrate may comprise cobalt-cemented tungsten carbide.

Generally, a one-step PDC may be formed by placing un-bonded diamond particles adjacent to a cemented carbide substrate and subjecting the diamond particles and the cemented carbide substrate to an HPHT process under diamond-stable HPHT conditions. During the HPHT process, metal-solvent catalyst from the cemented carbide substrate at least partially melts and sweeps into interstitial regions between the diamond particles to catalyze growth of diamond and formation of diamond-to-diamond bonding between adjacent diamond particles so that a PCD table is formed that bonds to the cemented carbide substrate upon cooling from the HPHT process.

A two-step PDC may also be formed in which an at least partially leached PCD table (i.e., a freestanding PCD table formed in an initial HPHT process as discussed in more detail below) may be placed adjacent to a cemented carbide substrate and subjected to an HPHT process under diamond-stable conditions. During the HPHT process, an infiltrant from the cemented carbide substrate or other source at least partially infiltrates into the interstitial regions of the at least partially leached PCD table and bonds the at least partially infiltrated PCD table to the cemented carbide substrate upon cooling from the HPHT process.

The at least partially leached PCD table may be formed by separating the PCD table from a one-step PDC by removing the cemented carbide substrate via any suitable process (e.g., grinding, machining, laser cutting, EDM cutting, or combinations thereof) and leaching the metal-solvent catalyst from the PCD table in a suitable acid. The at least partially leached PCD table may also be formed by other methods, such as sintering diamond particles in the presence of a metal-solvent catalyst to form a PCD table or disk and leaching the PCD table in a suitable acid.

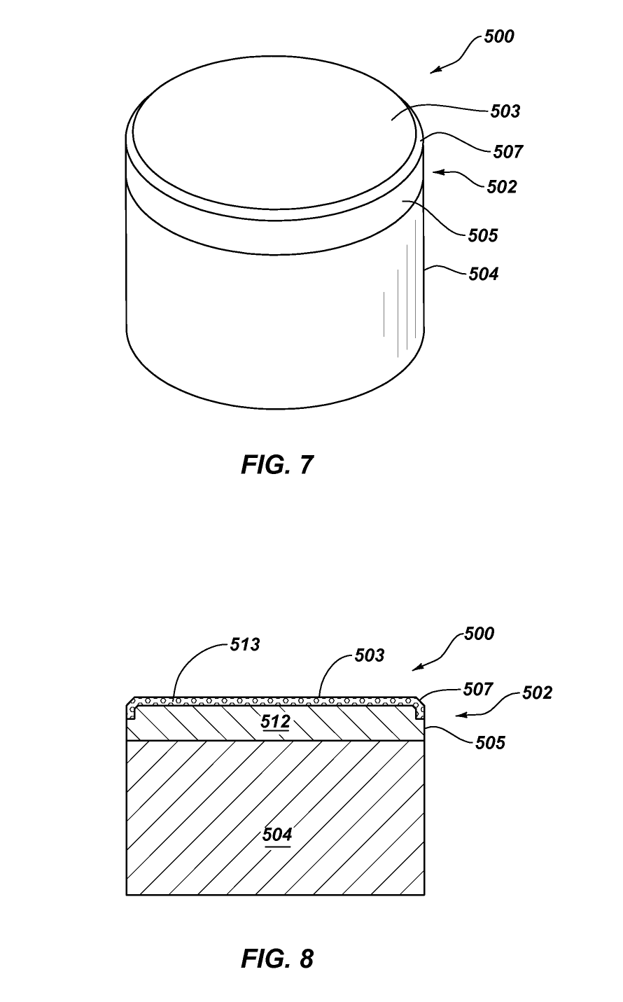

Referring to FIG. 8, either a one-step or a two-step PDCs may be subjected to an optional leaching process to remove a portion of the metal-solvent catalyst or infiltrant from the PCD table to a selected depth and from one or more exterior surfaces to form a leached region 510, with the underlying unaffected region of the PCD table 502 labeled as 512. Removal of the metal-solvent catalyst or infiltrant may help improve thermal stability and/or wear resistance of the PCD table during use. Example acids used in leaching include, but are not limited to, aqua regia, nitric acid, hydrofluoric acid, and mixtures thereof. For example, leaching the PCD table 502 may form the leached region 510 that extends inwardly from the exterior surface 503, the lateral surface 505, and the chamfer 507 to a selected leached depth. The selected leached depth may be about 100 μm to about 1000 μm, about 100 μm to about 300 μm, about 300 μm to about 425 μm, about 350 μm to about 400 μm, about 350 μm to about 375 μm, about 375 μm to about 400 μm, about 500 μm to about 650 μm, or about 650 μm to about 800 μm.

The bonded-together diamond grains of the PCD table may exhibit an average grain size of about 100 μm or less, about 40 μm or less, such as about 30 μm or less, about 25 μm or less, or about 20 μm or less. For example, the average grain size of the diamond grains may be about 10 μm to about 18 μm, about 8 μm to about 15 μm, about 9 μm to about 12 μm, or about 15 μm to about 25 μm. In some embodiments, the average grain size of the diamond grains may be about 10 μm or less, such as about 2 μm to about 5 μm or submicron.

The diamond particle size distribution of the diamond particles that are HPHT processed may exhibit a single mode, or may be a bimodal or greater grain size distribution. In an embodiment, the diamond particles may comprise a relatively larger size and at least one relatively smaller size. As used herein, the phrases “relatively larger” and “relatively smaller” refer to particle sizes (by any suitable method) that differ by at least a factor of two (e.g., 30 μm and 15 μm). According to various embodiments, the diamond particles may include a portion exhibiting a relatively larger average particle size (e.g., 50 μm, 40 μm, 30 μm, 20 μm, 15 μm, 12 μm, 10 μm, 8 μm) and another portion exhibiting at least one relatively smaller average particle size (e.g., 6 μm, 5 μm, 4 μm, 3 μm, 2 μm, 1 μm, 0.5 μm, less than 0.5 μm, 0.1 μm, less than 0.1 μm). In an embodiment, the diamond particles may include a portion exhibiting a relatively larger average particle size between about 10 μm and about 40 μm and another portion exhibiting a relatively smaller average particle size between about 1 μm and 4 μm. In some embodiments, the diamond particles may comprise three or more different average particle sizes (e.g., one relatively larger average particle size and two or more relatively smaller average particle sizes), without limitation.

As described above, the PCD table 502 may be formed separately from or integral with the substrate 504 in an HPHT process. When formed separately, the PCD table 502 may be subsequently attached to the substrate 504 in another HPHT process (i.e., the PCD is fabricated in a two-step process). The temperature of such HPHT processes may typically be at least about 1000° C. (e.g., about 1200° C. to about 1600° C.) and the pressure of the HPHT process may typically be at least about 4.0 GPa (e.g., about 5.0 GPa to about 12.0 GPa, about 7.0 GPa to about 9.0 GPa, about 6.0 GPa to about 8.0 GPa, or about 9.0 GPa to about 12.0 GPa).

Additional details about one-step and two-step PDCs and other PCD elements that may be tested using any of the testing/characterization techniques disclosed herein can be found in U.S. Pat. Nos. 7,866,418 and 8,236,074; and U.S. application Ser. No. 12/961,787, the contents of each of the foregoing patents and applications is incorporated herein, in their entirety, by this reference.

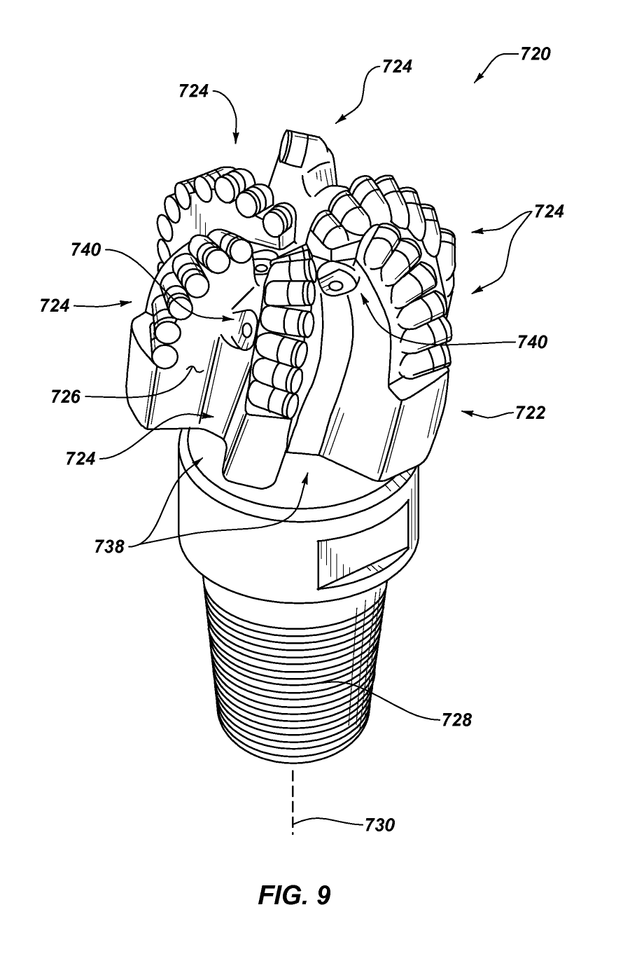

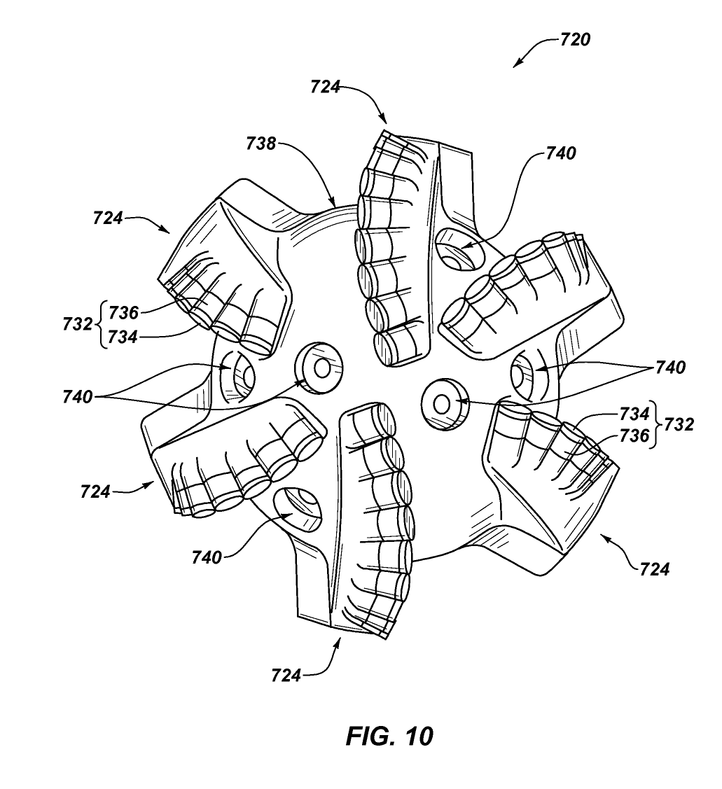

The tested/characterized/designed PCD elements may be used in a variety of applications, such as PCD cutting elements on rotary drill bits. FIG. 9 is an isometric view and FIG. 10 is a top elevation view of an embodiment of a rotary drill bit 720. The rotary drill bit 720 includes at least one PCD element, such as a PDC, tested/characterized/designed according to any of the previously described methods. The rotary drill bit 720 comprises a bit body 722 that includes radially and longitudinally extending blades 724 with leading faces 726, and a threaded pin connection 728 for connecting the bit body 722 to a drilling string. The bit body 722 defines a leading end structure for drilling into a subterranean formation by rotation about a longitudinal axis 730 and application of weight-on-bit. At least one PCD cutting element 732, configured according to any of the previously described PCD elements (e.g., the PDC shown in FIG. 7), may be affixed to the bit body 722. With reference to FIG. 10, each of a plurality of PCD cutting elements 732 is secured to the blades 724. For example, each cutting element 732 may include a PCD table 734 bonded to a substrate 736. More generally, the cutting elements 732 may comprise any PCD or other superabrasive element disclosed herein, without limitation. Also, circumferentially adjacent blades 724 so-called junk slots 738 are defined therebetween, as known in the art. Additionally, the rotary drill bit 720 may include a plurality of nozzle cavities 740 for communicating drilling fluid from the interior of the rotary drill bit 720 to the cutting elements 732.

FIGS. 9 and 10 merely depict one embodiment of a rotary drill bit that employs at least one cutting element that comprises a superabrasive compact suitable for analysis and fabrication in accordance with the disclosed embodiments, without limitation. The rotary drill bit 720 is used to represent any number of earth-boring tools or drilling tools, including, for example, core bits, roller-cone bits, fixed-cutter bits, eccentric bits, bicenter bits, reamers, reamer wings, or any other downhole tool including superabrasive compacts, without limitation.

The tested/characterized/designed PCD elements disclosed herein may also be utilized in applications other than cutting technology. For example, the disclosed tested/characterized/designed PCD elements may be used in wire dies, bearings, artificial joints, inserts, cutting elements, and heat sinks Thus, any of the tested/characterized/designed PCD elements disclosed herein may be employed in an article of manufacture including at least one superabrasive element or compact.

Thus, the embodiments of tested/characterized/designed PCD elements disclosed herein may be used in any apparatus or structure in which at least one conventional superabrasive compact is typically used. In one embodiment, a rotor and a stator, assembled to form a thrust-bearing apparatus, may each include one or more superabrasive compacts configured according to any of the embodiments disclosed herein and may be operably assembled to a downhole drilling assembly. U.S. Pat. Nos. 4,410,054; 4,560,014; 5,364,192; 5,368,398; and 5,480,233, the disclosure of each of which is incorporated herein, in its entirety, by this reference, disclose subterranean drilling systems within which bearing apparatuses utilizing PCD elements disclosed herein may be incorporated. The embodiments of the tested/characterized/designed PCD elements disclosed herein may also form all or part of heat sinks, wire dies, bearing elements, cutting elements, cutting inserts (e.g., on a roller-cone-type drill bit), machining inserts, or any other article of manufacture as known in the art. Other examples of articles of manufacture that may use any of the superabrasive compacts disclosed herein are disclosed in U.S. Pat. Nos. 4,811,801; 4,268,276; 4,468,138; 4,738,322; 4,913,247; 5,016,718; 5,092,687; 5,120,327; 5,135,061; 5,154,245; 5,180,022; 5,460,233; 5,544,713; 6,793,681; and 7,870,913, the disclosure of each of which is incorporated herein, in its entirety, by this reference.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

1. A method for characterizing a superabrasive element, the method comprising:
obtaining two images of the superabrasive element;
approximating a relationship between two-dimensional coordinates on the two images and three-dimensional coordinates on the superabrasive element using one or more projective transformation techniques; and
determining at least one dimension on the superabrasive element using the approximated relationship between the two-dimensional coordinates on the two images and the three-dimensional coordinates on the superabrasive element.

2. The method of claim 1 wherein approximating a relationship between two-dimensional coordinates on the two images and three-dimensional coordinates on the superabrasive element using one or more projective transformation techniques includes approximating the relationship between the two-dimensional coordinates on the two images and the three-dimensional coordinates using one or more direct linear transformation techniques.

3. The method of claim 1 wherein obtaining two images of the superabrasive element includes obtaining the two images of the superabrasive element using two imaging devices, one imaging device and one prism, one imaging device and an arrangement of mirrors, or one imaging device including two separate images.

4. The method of claim 1 wherein obtaining two images of the superabrasive element includes obtaining the two images of the superabrasive element and a calibration device.

5. The method of claim 4 wherein the calibration device is configured to provide one or more points of known location to enable approximation of the relationship between the two-dimensional coordinates on the two images and the three-dimensional on the superabrasive element.

6. The method of claim 1 wherein determining at least one dimension on the superabrasive element using the approximated relationship between the two-dimensional coordinates on the two images and the three-dimensional coordinates on the superabrasive element includes determining three-dimensional coordinates of one or more points of interest on the superabrasive element using the approximated relationship.

7. The method of claim 6 wherein determining three-dimensional coordinates of one or more points of interest on the superabrasive element using the approximated relationship includes determining a wear flat area using the three-dimensional coordinates of the one or more points of interest.

8. The method of claim 1 wherein the superabrasive element includes a polycrystalline diamond table bonded to a substrate.

9. The method of claim 1 wherein the superabrasive element includes a freestanding polycrystalline diamond element without a substrate.

10. A method for designing a manufacturing process for a polycrystalline diamond (“PCD”) element, the method comprising:
cutting a workpiece with a first PCD element so that the first PCD element develops a wear flat;
determining a wear characteristic of the first PCD element using one or more projective transformation techniques; and
modifying a manufacturing process used to fabricate the first PCD element at least partially based on the wear characteristic.

11. The method of claim 10 wherein the first PCD element includes a polycrystalline diamond compact.

12. The method of claim 10 wherein the first PCD element includes a PCD table bonded to a substrate.

13. The method of claim 10 wherein determining a wear characteristic of the first PCD element using one or more projective transformation techniques includes:
obtaining two images of the first PCD element;
approximating a relationship between two-dimensional coordinates on the two images and three-dimensional on the first PCD element; and
determine the wear flat area on the first PCD element using the approximated relationship.

14. A method for characterizing a superabrasive cutting element mounted to a bit body of a rotary drill bit, the method comprising:
obtaining two images of the superabrasive cutting element that is mounted to the bit body;
approximating a relationship between two-dimensional coordinates on the two images and three-dimensional coordinates on the superabrasive cutting element using one or more projective transformation techniques; and
determining a wear characteristic of the superabrasive cutting element using the approximated relationship between the two-dimensional coordinates on the two images and the three-dimensional coordinates on the superabrasive cutting element.

15. The method of claim 14 wherein approximating a relationship between two-dimensional coordinates on the two images and three-dimensional coordinates on the superabrasive cutting element using one or more projective transformation techniques includes approximating the relationship between the two-dimensional coordinates on the two images and the three-dimensional coordinates using one or more direct linear transformation techniques.

16. The method of claim 14 wherein obtaining two images of a superabrasive cutting element includes obtaining the two images of the superabrasive cutting element using two imaging devices, one imaging device and one prism, one imaging device and an arrangement of mirrors, or one imaging device including two separate images.

17. The method of claim 14 wherein obtaining two images of a superabrasive cutting element includes obtaining the two images of the superabrasive element and a calibration device.

18. The method of claim 14 wherein determining a wear characteristic of the superabrasive cutting element using the approximated relationship between the two-dimensional coordinates on the two images and the three-dimensional coordinates on the superabrasive cutting element includes determining three-dimensional coordinates of one or more points of interest on the superabrasive cutting element using the approximated relationship.

19. The method of claim 14 wherein determining three-dimensional coordinates of one or more points of interest on the superabrasive cutting element using the approximated relationship comprises determining a wear flat area using the three-dimensional coordinates of the one or more points of interest.

20. A computer readable medium having computer executable instructions stored thereon that when executed by at least one processor causes the processor to perform a method for characterizing a superabrasive element, the method including:
obtaining two images of the superabrasive element;
approximating a relationship between two-dimensional coordinates on the two images and three-dimensional coordinates on the superabrasive element using one or more projective transformation techniques; and
determining at least one dimension on the superabrasive element using the approximated relationship between the two-dimensional coordinates on the two images and the three-dimensional coordinates on the superabrasive element.

21. A computer system, comprising:
at least one processor; and
a memory to which the at least one processor is operably coupled, the memory storing computer executable instructions thereon that when executed by the at least one processor causes the at least one processor to perform a method for characterizing a superabrasive element, the method including:
obtaining two images of the superabrasive element;
approximating a relationship between two-dimensional coordinates on the two images and three-dimensional coordinates on the superabrasive element using one or more projective transformation techniques; and
determining at least one dimension on the superabrasive element using the approximated relationship between the two-dimensional coordinates on the two images and the three-dimensional coordinates on the superabrasive element.
